(19) United States
(12) Patent Application Publication
(10) Pub. No.: US 2002/0032758 A1
(43) Pub. Date: Mar. 14, 2002

(54) Method and system for dynamically loading program logic into an application

(76) Inventors: Hsiang Tsun Yen, Taipei (TW); Chien Sen Weng, Taipei (TW); Luke Taylor, Taipei (TW)

Correspondence Address: Michael D. Bednarek, SHAWPITTMAN, 1650 Tysons Boulevard, McLean, VA, 22102-4859, US

(21) Appl. No.: 09/825,068

(22) Filed: Apr. 4, 2001

(30) Foreign Application Priority Data
Sep. 14, 2000 (TW) 089119025

(51) Int. Cl. G06F 15/177

(52) U.S. Cl. 709/220

(57) ABSTRACT

The present invention relates to a method and system for dynamically loading program logic into an application. The method comprises the following steps. The client computer launches an application to issue a request to a server. The server receives the request and transfers a configuration file to the client computer based on the request. The configuration file comprises a program logic file name and a program logic file address. The program logic file address corresponds to a storage apparatus where the program logic file corresponding to the program logic file name is located. The program logic file comprises the program logic required to execute the application. The client computer receives the configuration file, links to the storage apparatus corresponding to the program logic file address and downloads the program logic file. The client computer executes the application in accordance with program logic in the program logic file.

### REFERENCE TO RELATED APPLICATIONS

The present application claims priority to Taiwan application No. 089119025, entitled “Method and System for Dynamically Loading Program Logic into an Application,” filed on Sep. 14, 2000.

### BACKGROUND OF THE INVENTION

1. Field of the Invention

The present invention relates to a method and system for dynamically loading program logic into an application.

2. Description of the Related Art

When an application is executed, it follows program logic. Program logic is used to determine the executing order of an application. For example, the layout of an image or the order and spacing of content displayed is determined by program logic.

In prior art, the program logic of an application is written by programmers so that as users launch the application, it follows the program logic and completes designated tasks.

In a network environment, with client/server architecture, programmers install applications at the client computer and store data required by applications on the server. As a result, when an application is launched, it retrieves data via network. As such, application users can access the latest data each time launching the application without worries of data expiry.

As program logic is written into applications, when users update data from the server, which requires up to date display logic, it is necessary to download, reinstall and execute the updated version of an application to enable the display and processing of updated data from the server.

From a user's perspective, downloading an updated version of an application, as a result of the need for updated data or program logic, is a complicated and time-consuming procedure.

### SUMMARY OF THE INVENTION

It is therefore an object of the present invention to provide a method and system that dynamically loads program logic into an application. In the system provided, in accordance with the invention, program logic is not written into the application to be installed at the client computer. Instead, program logic has to be retrieved from the server via network when the application is launched.

In a preferred embodiment, the present invention provides a method and system for dynamically loading program logic into an application. The method comprises the following steps. First, the client computer launches an application to issue a request to a server. The server receives the request and transfers a configuration file to the client computer based on the request. The configuration file comprises a program logic file name, and a program logic file address. The program logic file address corresponds to a storage apparatus where the program logic file corresponding to the program logic file name is located. The program logic file comprises the program logic required to execute the application. Then, the client computer receives the configuration file, and link to the storage apparatus corresponding to the program logic file address and downloads the program logic file which corresponds to the program logic file name according to the program logic file address in the configuration file. Next, the client computer executes the application in accordance with program logic in the program logic file.

It is an advantage of the present invention that when updated data requires updated program logic, users do not have to update program logic by downloading an updated version of the application. Instead users can download required program logic from the server.

These and other objectives of the present invention will no doubt become obvious to those of ordinary skill in the art after having read the following detailed description of the preferredembodiment, which is illustrated in the various figures and drawings.

### BRIEF DESCRIPTION OF DRAWINGS

The following detailed description, given by way of an example and not intended to limit the invention to the embodiments described herein, will best be understood in conjunction with the accompanying drawings, in which:

FIG. 1 illustrates a diagram of a system in accordance with the first preferred embodiment of the invention;

FIG. 2 illustrates a configuration file diagram of one preferred embodiment in accordance with the invention;

FIG. 3 illustrates a diagram of program logic file of the system in accordance with the invention as shown in FIG. 1;

FIG. 4 illustrates a diagram of a method in accordance with the first preferred embodiment of the invention;

FIG.5 illustrates a flowchart of program interpreter operations in accordance with one preferred embodiment of the invention;

FIG. 6 illustrates another interpreting flowchart of program interpreter according to one preferred embodiment of the invention;

FIG. 7 illustrates a diagram of a system in accordance with the second preferred embodiment of the invention;

FIG. 8 illustrates a configuration file diagram of the second preferred embodiment in accordance with the invention as shown in FIG. 7; and

FIG. 9 illustrates a diagram of a system in accordance with the second preferred embodiment of the invention.

### DETAILED DESCRIPTION OF THE INVENTION

In the invention, the program logic of an application is stored in a server. As the client computer executes an application, it issues a request to the server. The server then offers the required program logic based on the request from client computer.

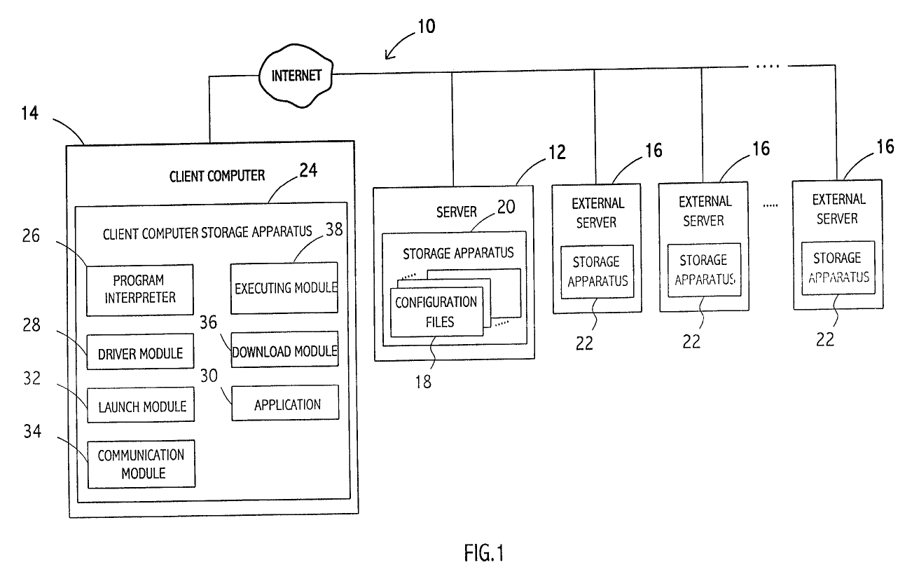

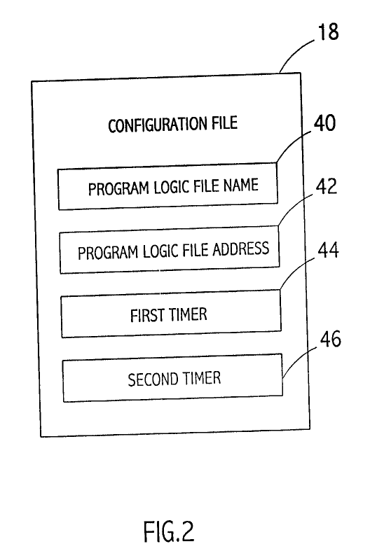

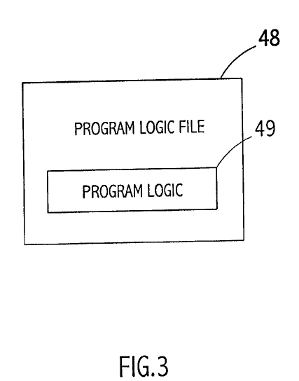

FIG. 1 illustrates a first preferred embodiment of a system 10, FIG. 2 illustrates a diagram of a configuration file 18 in the system 10, and FIG. 3 illustrates a diagram of a program logic file 48 in the system 10. System 10 comprises a server 12, a client computer 14, and a plurality of external servers 16.

Each external server 16 comprises a storage apparatus 22. Client computer 14 comprises a client computer storage apparatus 24, having a program interpreter 26, a driver module 28, an application 30, a launch module 32, a communication module 34, a download module 36, and an executing module 38. Server 12 comprises a plurality of configuration files 18, stored in storage apparatus 20. Each configuration file 18 comprises a program logic file name 40, a program logic file address 42, a first timer 44, and a second timer 46.

The file address of program logic 42 is corresponding to a predetermined position of the storage apparatus 20 or 22. Program logic file 48 stored in the storage apparatus 20 or 22, corresponds to program logic file name 40, which comprises program logic 49 required for executing application 30.

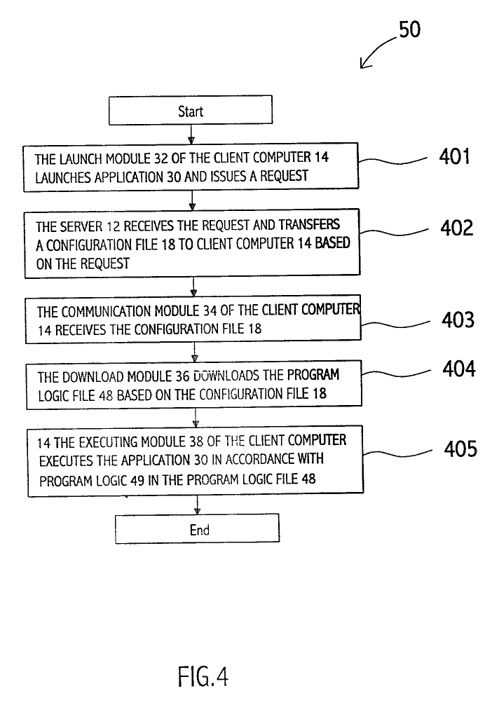

FIG. 4 is a first preferred embodiment of a method 50 according to the invention. Method 50 comprises the following steps. In step 401, the launch module 32 of the client computer 14 launches application 30 and issues a request.

In step 402, the server 12 receives the request and transfers a configuration file 18 to client computer 14 based on there quest.

In step 403, the communication module 34 of the client computer 14 receives the configuration file 18.

In step 404, the download module 36 of the client computer 14 links to the storage apparatus 20 or 22 corresponding to the program logic file address 42 in the configuration file 18 client computer to download the program logic file 48 corresponding to the program logic file name 40 in the configuration file 18.

In step 405, the executing module 38 of the client computer 14 executes the application 30 in accordance with program logic 49 in the program logic file 48.

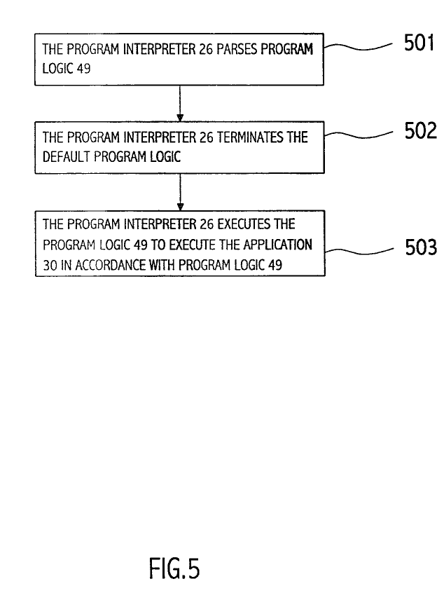

FIG. 5 illustrates a flowchart of operations for a program interpreter 26. In FIG. 5, a default program logic file is stored at the client computer 14. When launch module 32 at the client computer launches application 30, the client computer 14 executes application 30 based on the default program logic in the default program logic file. In step 405, the program interpreter 26 executes the following steps.

In step 501, the program interpreter 26 parses program logic 49 in the program logic file 48.

In step 502, the program interpreter 26 terminates the default program logic in the default program logic file.

In step 503, the program interpreter 26 executes the program logic 49 in the program logic file 48 so as to enable the executing module 38 at client computer 14 to execute the application 30 in accordance with program logic 49.

Furthermore, client computer 14 stores the configuration file 18 and the program logic file 48 in client computer storage apparatus 24 to replace the default program logic file with the program logic file 48.

Program interpreter 26 can either be included in the operating system of client computer 14 or in application 30.

In the present invention, program interpreter 26 is a browser engine (HTML engine) . The browser engine can be used either to display HTML format information, or functioned as an interpreter between Script language and DHTML language. Accordingly, program logic in application 30 is written with Script language, and renders objects and content effect in DHTML language.

In the preferred embodiment, the browser engine is set as Microsoft Explorer, the operating system is set as Microsoft Windows at client computer 14.

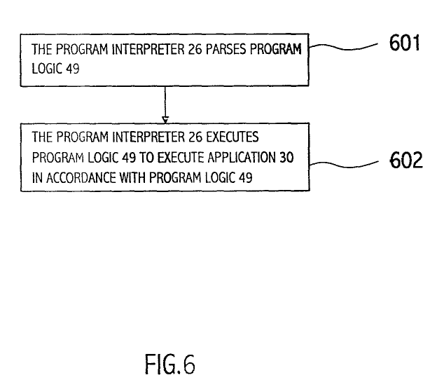

FIG. 6 shows another flowchart of operations for program interpreter 26. Provided there is no default program logic file saved at client computer 14 and program logic file 48 is downloaded by download module 36, in step 405, the program interpreter 26 executes the following steps.

In step 601, the program interpreter 26 parses program logic 49 in the program logic file 48.

In step 602, the program interpreter 26 executes program logic 49 in program logic file 48 and enables execute module 38 at client computer 14 to execute application 30 in accordance with program logic 49.

In addition, client computer 14 stores configuration file 18 and program logic file 48 in client computer storage apparatus 24. Thereafter, the client computer executes method 50, and the stored program logic file 48 substitutes the default program logic file. As a result, when launch module 32 launches application 30, client computer 14 executes application 30 according to the program logic 49 of program logic file 48.

Configuration file 18 can exist as an independent file stored at client computer 14, or incorporated into the operating system register file.

Among a plurality of configuration files 18 at server 12, each corresponds to different program logic and generates different results from the execution of application 30. Accordingly, server 12 controls the result from the execution of application 30 by transferring desired configuration file 18 to client computer 14. As client computer 14 issues a request to server 12, by a responding configuration file from server 12 controls the file the execution result of application 30.

First timer 44 of configuration file 18 enables client computer 14 to execute method 50 at preset times. Server 12 transfers an updated configuration file to client computer 14 and enables client computer 14 to link to an alternative storage apparatus and download a new program logic file, which has new program logic for the execution of application 30.

Server 12 controls client computer 14 by setting first timer 44 to load different program logic at set times. Each program logic renders different application results. For example, client computer 14 downloads program logic in the morning, which enables application 30 to generate a stock quote reporter, which reports stock quotes real-time. It follows that server 12 controls client computer 14 with first timer 44 by enabling client computer 14 to download alternative program logic in the afternoon to execute application 30 to generate a stock market analysis reporter, which offers stock market analysis for the day. The program logic for a stock quote reporter is different from that for a stock market analysis reporter; moreover, both are stored in different storage apparatus. Server 12 via first timer 44 therefore controls client computer 14. Client 14 is linked to respective storage apparatus and downloads designated program logic for different purposes. In the example above, client computer 14 functions as a stock quote reporter in the morning; and is automated to function as a stock market analysis reporter in the afternoon.

Second timer 46 of configuration file 18 initializes launch module 32, download module 36 and executing module at client computer 14 at preset times. Client computer 14 links to the same storage apparatus to download the latest program logic file which application 30 has to follow when executing.

Server 12 retrieves program logic files from the same storage apparatus for updates. Therefore, client computer 14 is controlled by server 12 with second timer 46 set up in the program logic file, enabling client computer 14 to be updated with the latest program logic.

For example, client computer 14 downloads the first program logic for the execution of application 30 to be a stock quote reporter. In the afternoon, server 12 substitutes this program logic with the second program logic, and uses second timer 46 to control client computer 14. In this way, the client computer links to the same storage apparatus and downloads the second program logic for the execution of application 30 to be a stock market analysis reporter.

In other words, the program logic needed to generate a stock quote reporter and a stock market analysis reporter, are stored on the same storage apparatus. At a preset time, server 12 substitutes program logic for a stock quote reporter with one for a stock market analysis reporter. Thus, server 12 controls client computer 14 with second timer 46, updating program logic by linking to the storage apparatus. In the example, client computer 14 displays a stock quote reporter in the morning and is automated to display a stock quote reporter.

Driver module 28 at client computer 14 is used to initialize client computer 14 to re-execute method 50. As users launch driver module 28 for example by clicking the graphic button, a menu of executing results pops up on the screen at client computer 14 for users to make a selection. The results include a graphic application, a word processor, a calculator, a stock quote reporter, a stock market analysis reporter, a messenger, or an astrology discussion board etc. The user selects an option on the menu, client computer 14 launches application 30 and issues the related request to server 12. It follows that server 12 then transfers a specific configuration file, corresponding to the option selected at client computer 14. Client computer 14 links to the designated storage apparatus to download the designated program logic file, proceeds to the execution of the application and renders the result the user desired.

That means, among a plurality of configuration files 18 at server 12, each one corresponds to separate program logic and renders different results when an application is executed. Accordingly, server 12 transfers designated configuration file 18 to client computer 14 based on the request made, to meet client requirements.

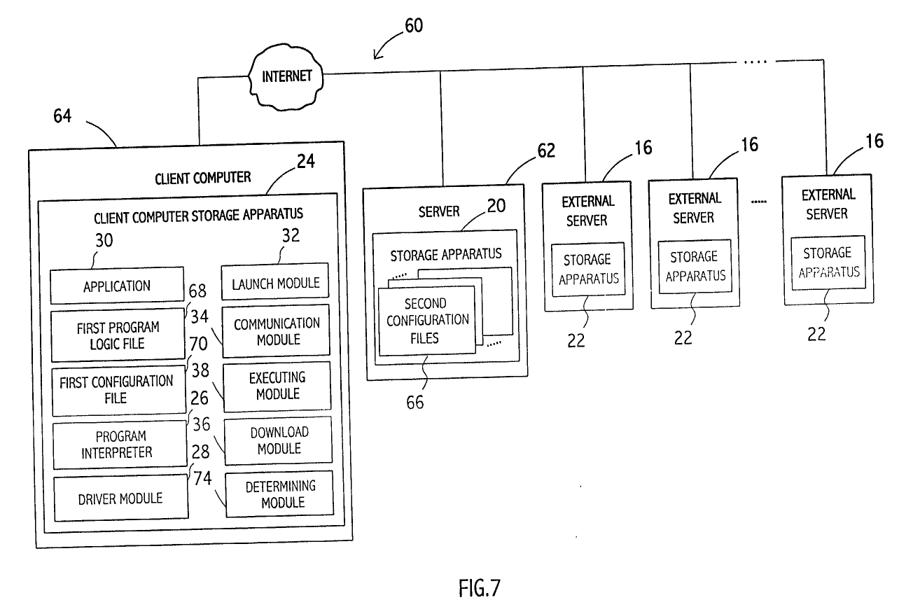

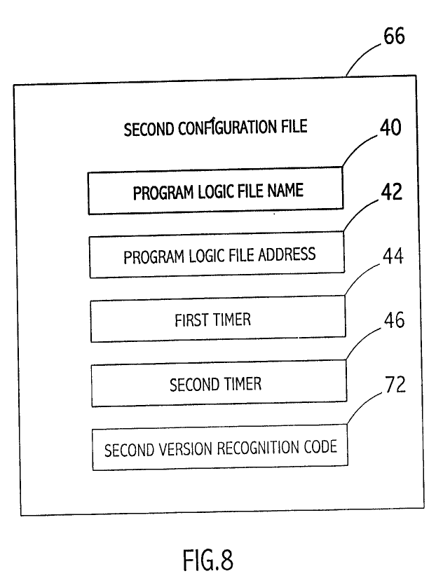

FIG. 7 shows a second preferred embodiment of a system 60 of the present invention, and FIG. 8 illustrates a diagram of a second configuration file 66 in the system 60. The distinction between system 60 and system 10 lies in that the client computer 64 further comprises a first program logic file 68 and a first configuration file 70, wherein first program logic file 68 comprises first program logic and first configuration file 70 comprises a first version recognition code corresponding to first program logic file 68. Second configuration file 66 at server 62 further comprises a second version recognition code 72. Client computer 64 further comprises a determining module 74 used to determine whether the transferred second version recognition code 72 of the second configuration file 66 from server 62 and the first version recognition code of the first configuration file 70 are identical or not.

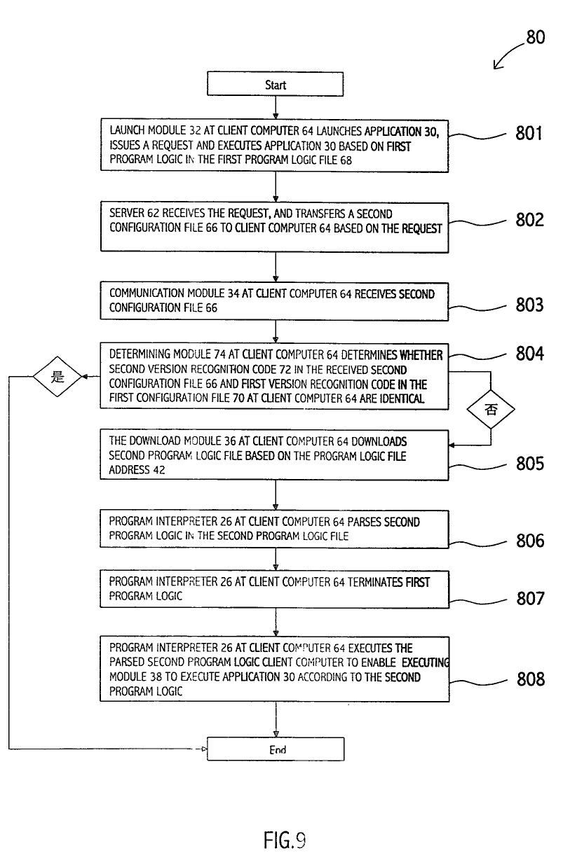

FIG. 9 shows a second preferred embodiment of a method 80 of the present invention. Method 80 comprises the following steps.

In step 801, launch module 32 at client computer 64 launches application 30, issues a request and executes application 30 based on first program logic in the first program logic file 68.

In step 802,server 62 receives the request, and transfers a second configuration file 66 to client computer 64 based on the request.

In step 803, communication module 34 at client computer 64 receives second configuration file 66.

In step 804, determining module 74 at client computer 64 determines whether second version recognition code 72 in the received second configuration file 66 and first version recognition code in the first configuration file 70 at client computer 64 are identical. If yes, method 80 terminates, and client computer 64 continues to follow first program logic in executing application 30. If not, then step 805 is executed.

In step 805, the download module 36 at client computer 64 links to storage apparatus 20 or 22 corresponding to the program logic file address 42 and downloads second program logic file, corresponding to the program logic file name 40 based on the program logic file address 42 in the second configuration file 66.

In step 806, program interpreter 26 at client computer 64 parses second program logic in the second program logic file.

In step 807, program interpreter 26 at client computer 64 terminates first program logic.

In step 808, program interpreter 26 at client computer 64 executes the parsed second program logic client computer to enable executing module 38 at client computer 64 to execute application 30 according to the second program logic.

As shown in FIG. 8, second version recognition code 72 can be a version of serial numbers, and it can also be the update time of the file, which means that chronological order can serve the same identifying purpose as version of serial numbers. The same feature also applies to first version recognition code.

The main distinction between method 80 and method 50 is that as method 80 uses version recognition code to determine whether the second program logic file is the latest version, it only downloads updated program logic file, when the second program logic file is newer than first program logic file. Therefore, when the version of the second program logic file is not newer than first program logic file 68, client computer 64 follows first program logic in the first program logic file 68 when executing application 30, without updating the second program logic file.

In addition, because second version recognition code differs from first version recognition code, the client computer downloads the second program logic file. Thereafter, client computer 64 stores received second configuration file 66 in client computer storage apparatus 24, and substitutes the first configuration file 70 with stored second configuration file 66. At the same time, client computer 64 substitutes the first program logic file 68 stored at the client computer storage apparatus 24 with the second program logic file.

In system 10 and 60, in accordance with the present invention, server 12 and 62 control the execution results of application 30 by use of timers. For example, servers 12 and 62 control client computers 14 and 64, to display a stock quote reporter in the morning and change from the stock quote reporter to a stock market analysis reporter in the afternoon.

Servers 12 and 62 control application 30 at client computers 14 and 64 to display a stock market analysis reporter. By using a timer, application 30 further generates displays, for example a calculator and messenger that enable users to deal with multitasking. While browsing the stock market analysis reporter, users can make stock share associated calculations with the calculator and share stock market information with associates using the messenger. This means that by using timers, servers 12 and 62 control client computers 14 and 64, to render different results in the execution of application 30. As a result, users at client computer 14 and 64 can simultaneously use a stock market analysis reporter, a calculator and messenger.

With driver module 28, users at client computers 14 and 64 select a desired execution for application 30. For example, client computers 14 and 64 are controlled by servers 12 and 62 to display a stock market analysis reporter in the afternoon. However, by directing driver module 28, users can select other execution results such as a calculator and messenger. Consequentially, this allows users not only to browse the information displayed on the stock market analysis reporter, but also to make financial calculations with the generated calculator and exchange share information with friends, using the messenger.

Different from the prior art, client computer 14 in system 10 and client computer 64 in system 60 dynamically download program logic into application 30. This means application 30 does not comprise program logic, instead required program logic is downloaded from servers 12 and 62 or external server 16. With different program logic, application 30 renders different execution results. Accordingly, client computers 14 and 64 do not have to re-install the entire application when program logic updated and prepare different program logic applications for different results.

While the invention has been described with reference to various illustrative embodiments, the description herein should not be construed in a limiting sense. Various modifications of the illustrative embodiments, as well as other embodiments of the invention, will be apparent to those skilled in the art upon reference to this description. It is therefore contemplated that the appended claims will cover any such modifications or embodiments as may fall within the scope of the invention defined by the following claims and their equivalents.

What is claimed is:

1. A method for dynamically loading program logic, comprising:
(a) launching an application from client computer that issues a request;
(b) receiving the request at the server and transferring a configuration file to the client computer based on said request, wherein the configuration file comprises a program logic file name, and a program logic file address, and the program logic file address corresponds to a storage apparatus where the program logic file corresponding to the program logic file name is located, said program logic file comprises the program logic required to execute the application;
(c) receiving the configuration file at client computer;
(d) linking to the storage apparatus corresponding to the program logic file address and downloading the program logic file which corresponds to the program logic file name, according to the program logic file address corresponding to the program logic file name in the configuration file from client computer; and
(e) executing the application in accordance with program logic in the program logic file at the client computer.

2. The method according to claim 1, wherein the storage apparatus is an external server.

3. The method according to claim 1, wherein the server further comprises a storage apparatus.

4. The method according to claim 1, wherein the client computer further comprises a client computer storage apparatus used to store the configuration file.

5. The method according to claim 1, wherein the client computer further comprises a client computer storage apparatus used to store the program logic file.

6. The method according to claim 1, wherein the client computer further comprises a program interpreter and executes default program logic in the default program logic file while launching the application from the client computer, and in step (e), the program interpreter executes the following steps:
parsing program logic of the program logic file;
terminating default program logic in the default program logic file; and
executing program logic in the program logic file, thereby completing application execution.

7. The method according to claim 6, wherein the client computer receives a program logic file replacing the default program logic file.

8. The method according to claim 1, wherein the client computer further comprises a program interpreter, which executes the following steps in step (e):
parsing program logic of the program logic file; and
executing program logic in the program logic file, thereby completing application execution.

9. The method according to claim 1, wherein the configuration file further comprises a timer used for initializing the execution of steps (a) and (e) from client computer at preset times.

10. The method according to claim 1, wherein the configuration file further comprises a timer used for initializing the execution of steps (a), (d) and (e) from client computer at preset times.

11. The method according to claim 1, wherein the client computer further comprises a driver module used to initialize the execution of steps (a) and (e) from client computer.

12. A method for dynamically loading program logic comprising:
(a) launching an application and making a request from the client computer, wherein upon launch, a first program logic is executed and the client computer comprises a first program logic file comprising the first program logic and a first configuration file, comprising first version recognition code corresponding to the first program logic file;
(b) receiving the request at server and transferring a second configuration file to the client computer based on said request, and wherein the second configuration file comprises a program logic file name, a program logic file address and a second version recognition code, wherein the program logic file address corresponds to a storage apparatus where the second program logic file corresponding to the file name of program logic is located, and the second program logic file comprises a second program logic required for application execution, wherein the second version recognition code corresponds to the second program logic;
(c) receiving the second configuration file from client computer;
(d) determining whether the second version recognition code and the first version recognition code are identical at the client computer, if yes, the application execution proceeds in accordance with the first program logic, if not, executing step (e);
(e) linking to the storage apparatus corresponding to the program logic file address and downloading the second program logic file corresponding to program logic filename in the second configuration file from the client computer; and
(f) executing the application at the client computer according to the second program logic in the second program logic file.

13. The method according to claim 12, wherein the storage apparatus is an external server.

14. The method according to claim 12, wherein the server further comprises a storage apparatus.

15. The method according to claim 12, wherein the client computer replaces the first configuration file with the second configuration file.

16. The method according to claim 12, wherein the client computer further comprises a program interpreter which executes the following steps in step (f):
parsing second program logic in the second program logic file;
terminating first program logic; and
executing second program logic in the second program logic file and completing application execution.

17. The method according to claim 12, wherein the client computer replaces the first program logic file with the second program logic file.

18. The method according to claim 12, wherein the configuration file further comprises a timer used to initialize the execution of steps (a) and (f) at the client computer at preset times.

19. The method according to claim 12, wherein the configuration file further comprises a timer used to initialize the execution of steps (a), (e) and (f) at the client computer at preset times.

20. The method according to claim 12, wherein the client computer further comprises a driver module used to initialize the execution of steps (a) and (f) at the client computer.

21. A system for dynamically loading program logic comprising:
a server, comprising:
a plurality of configuration files, each configuration file comprising a program logic file name and a program logic file address, wherein the program logic file address corresponds to a storage apparatus, where the program logic file corresponding to the program logic file name is located, and the program logic file comprises the program logic required for application execution;
a client computer, comprising:
a client computer storage apparatus used to store the application;
a launch module used to launch the application;
a communication module used to receive the configuration files transferred from the server;
a download module used to link to the storage apparatus corresponding to the program logic file address and downloads the program logic file corresponding to the program logic file name in the configuration file from client computer; and
an executing module used for application execution according to program logic in the program logic file.

22. The system according to claim 21, wherein the storage apparatus is an external server.

23. The system according to claim 21, wherein the server further comprises a storage apparatus.

24. The system according to claim 21, wherein the client computer stores received configuration files in the client computer storage apparatus.

25. The system according to claim 21, wherein the client computer stores program logic files in the client computer storage apparatus.

26. The system according to claim 21, wherein the client computer further comprises a program interpreter stored in the client computer storage apparatus and a default program logic file stored in the client computer storage apparatus, and the default program logic file comprises default program logic, which is launched when the application is launched by a launch module at the client computer, and the program interpreter is used to parse the program logic in the received program logic file, terminate default program logic, execute program logic in the program logic file and complete the application execution.

27. The system according to claim 26, wherein the client computer replaces the default program logic file with a received program logic file.

28. The system according to claim 21, wherein the client computer further comprises a program interpreter stored in the client computer storage apparatus used to parse program logic in the program logic file, executing the program logic in the program logic file thereby completing application execution.

29. The system according to claim 21, wherein the configuration file further comprises a timer used to initialize the launch module, communication module, download module and executing module at the client computer at preset times.

30. The system according to claim 21, wherein the configuration file further comprises a timer used to initialize the launch module, download module and executing module at the client computer at preset times.

31. The system according to claim 21, wherein the client computer further comprises a driver module, used to initialize launch module, communication module, download module and executing module at the client computer.

32. A system for dynamically loading program logic comprising:
a server comprising:
a plurality of second configuration files, wherein each second configuration file comprises a program logic file name, a program logic file address, and a second version recognition code, and the program logic file address corresponds to a storage apparatus where the second program logic file corresponding to the program logic file name is located, and the second program logic file comprises program logic required for application execution, and the second version recognition code corresponds to the second program logic file;
a client computer comprising:
a client computer storage apparatus used to store the application, a first program logic file and a first configuration file, wherein the first program logic file comprise first program logic, the first configuration file comprises a first version recognition code, corresponding to the first program logic file;
a launch module used to launch the application and simultaneously execute first program logic when the application is launched;
a communication module used to receive the second configuration file from the server;
a download module used to link to the storage apparatus corresponding to the program logic file address and downloads the second program logic file corresponding to the program logic file name in the second configuration file at client computer;
an executing module used to execute an application in accordance with first or second program logic; and
a determining module used to determine whether the second version recognition code and the first version recognition code are identical, if yes, the execution module executes the application in accordance with the first program logic, if not, the download module downloads the second program logic file corresponding to the program logic file name, and the execution module is initialized to execute the application in accordance with the second program logic in the second program logic file.

33. The system according to claim 32, wherein the storage apparatus is an external server.

34. The system according to claim 32, wherein the server further comprises a storage apparatus.

35. The system according to claim 32, wherein if the first version recognition code differs from the second version recognition code, the client computer replaces the first program logic file with the downloaded second program logic file.

36. The system according to claim 32, wherein if first version recognition code differs from second version recognition code, the client computer replaces the first configuration file with the second configuration file.

37. The system according to claim 32, wherein the client computer further comprises a program interpreter stored in the client computer storage apparatus which is used to parse the second program logic in the second program logic file, to terminate the first program logic, and to execute the second program logic in the second program logic file for completing the application execution.

38. The system according to claim 32, wherein the second configuration file further comprises a timer used to initialize the launch module, the communication module, the download module, the determining module and the executing module at the client computer at preset times.

39. The system according to claim 32, wherein the second configuration file further comprises a timer used to initialize the launch module, the download module and the executing module at the client computer at preset times.

40. The system according to claim 32, wherein the client computer further comprises a driver module used to initialize the launch module, the communication module, the download module, the determining module and the executing module at the client computer.
